(19) United States
(12) Patent Application Publication
(10) Pub. No.: US 2005/0039979 A1
(43) Pub. Date: Feb. 24, 2005

(54) Controlled descent rappelling mechanism

(76) Inventors: Patrick Gorman, White Lake, MI (US); Gerald DeMeyer, Rochester, MI (US); Timothy L. Wilcox, North Branch, MI (US); Avery Scott, Bloomfield Hills, MI (US)

Correspondence Address: HARNESS, DICKEY & PIERCE, P.L.C., P.O. BOX 828, BLOOMFIELD HILLS, MI, 48303, US

(21) Appl. No.: 10/866,173

(22) Filed: Jun. 11, 2004

Related U.S. Application Data
(60) Provisional application No. 60/477,571, filed on Jun. 11, 2003.

(51) Int. Cl. A62B 35/00

(52) U.S. Cl. 182/5

(57) ABSTRACT

A controlled descent mechanism with a self locking feature. The mechanism includes a belt with an end for attaching to a higher elevation and a free end. The belt is routed between moveable pins within the mechanism and slides across the pins as it moves through the mechanism. The pins can be moved toward one another to induce a dynamic friction within the mechanism to slow the rate of belt movement. The mechanism includes an attachment location for a user harness, and can be used to lower the user while controlling the rate of descent. The mechanism includes a self locking feature to automatically arrest the descent of the user.

### CROSS-REFERENCE TO RELATED APPLICATIONS

This application claims the benefit of U.S. Provisional Application No. 60/477,571, filed on Jun. 11, 2003. The disclosure of the above application is incorporated herein by reference.

### FIELD OF THE INVENTION

The present invention relates generally to a fall protection system and more specifically to a rappelling mechanism for controlled descent.

### BACKGROUND OF THE INVENTION

People working from heights have been known to fall from workstations and hunters in trees have fallen out of tree stands. Today there are many types of fall protection systems intended to arrest the fall of a person. One of these mechanisms is a life line that is connected to a harness worn by the user and connected to a stationary object. Also there exists mechanisms that allow a person to control their descent as they rappel. Conventional rappelling devices generally require that the user has specialized knowledge or training in the use of the devices. Additionally, these devices are sometimes bulky, heavy and expensive. Many conventional rappelling mechanisms are not self locking and require the user to actuate the rappelling mechanism in order to stop or slow the rate of descent. What is needed is a fall protection system that will restrain the fall of an individual and also provide a rappelling mechanism that is less complicated and easier to use.

### SUMMARY OF THE INVENTION

In accordance with the teachings of the present invention, a fall protection system with a rappelling mechanism is disclosed. In one form, the present invention provides a fall protection system that incorporates a harness with a rappelling mechanism and a pouch for storing a length of webbing. In another form, the present invention provides a rappelling mechanism including a pair of lock plates, a pair of release plates, a release pin, a pair of short pins, and a pivot pin. Additional advantages and features for the present invention will become apparent from the following detailed description taken in conjunction with the accompanying drawings. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of the controlled descent mechanism in accordance with the present invention;

FIG. 2 is a sectional view taken along line 2,2 of FIG. 1;

FIG. 3 is a perspective view of a fall protection system in accordance with the teachings of the present invention;

FIG. 4 is a perspective view of the pouch of FIG. 3 showing a top portion;

FIG. 5 is a perspective view of a release plate of the mechanism of FIG. 1;

FIG. 6 is a perspective view of a locking plate of the mechanism of FIG. 1; and

FIGS. 7 and 8 represent front and side views of an alternate rappelling mechanism according to the teachings of the present invention.

### DETAILED DESCRIPTION OF THE PREFERRED EMBODIMENTS

The following description of the preferred embodiment(s) is merely exemplary in nature and is in no way intended to limit the invention, its application, or uses.

The following description of embodiments of a fall protection system and controlled descent mechanism are exemplary in nature and in no way intended to limit the invention, its applications or uses. Moreover, while the present invention is described in detail with reference to fall protection, it will be appreciated by those skilled in the art that the present invention is not limited to a fall, but may also be used wherever a controlled descent mechanism would be required.

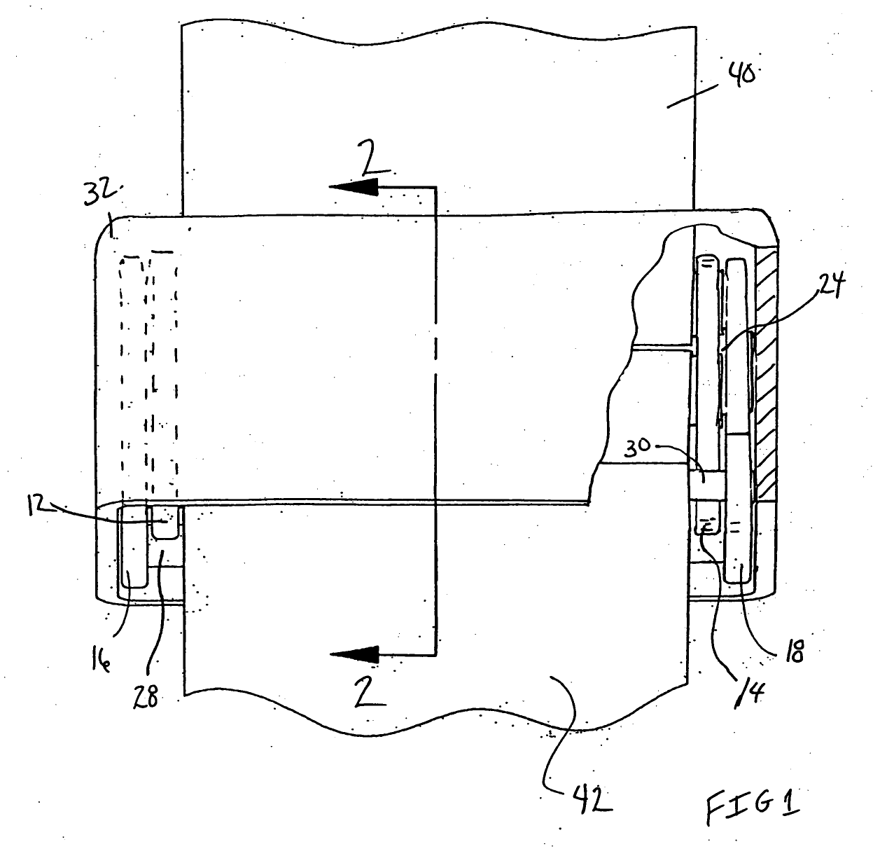

The rappelling mechanism 10 functions to selectively control the movement of the webbing 42 through the mechanism 10. To this end, by coupling a harness 52 to the mechanism 10, a user can selectively release or lock the harness to the webbing 42. As shown in FIG. 1, the locking plates 12 and 14 are held together in a generally parallel configuration by the pins 26, 28, and 30. Additionally disposed between the locking plates 12 and 14 is the pivot pin.

Similarly, the release plates 16 and 18 are parallelly configured and held together by pins 20 and 24. As described below, the lock plates 12 and 14 are rotationally coupled to the pin 26. Rotation of the release plates 16 and 18 with respect to the locking plates moves the locking pin 24 with respect to the short pins 20, 24.

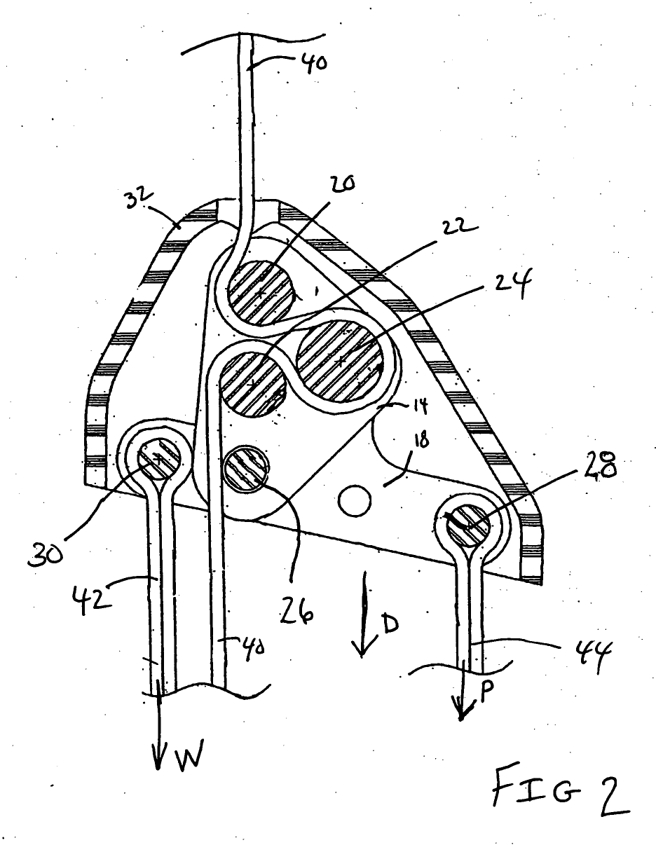

With reference to FIGS. 1 and 2, a controlled descent or rappelling mechanism in accordance with the teachings of the present invention is generally illustrated as reference numeral 10. Mechanism 10 includes a pair of lock plates 12, 14, a pair of release plates 16, 18, a pair of short pins 20, 22, a locking pin 24, a pivot pin 26, a release pin 28, an attachment pin 30, and a cover 32. Mechanism 10 is illustrated with a belt 40 inserted therein. An attachment webbing 42 is secured to attachment pin 30 and a release strap 44 is secured to release pin 28.

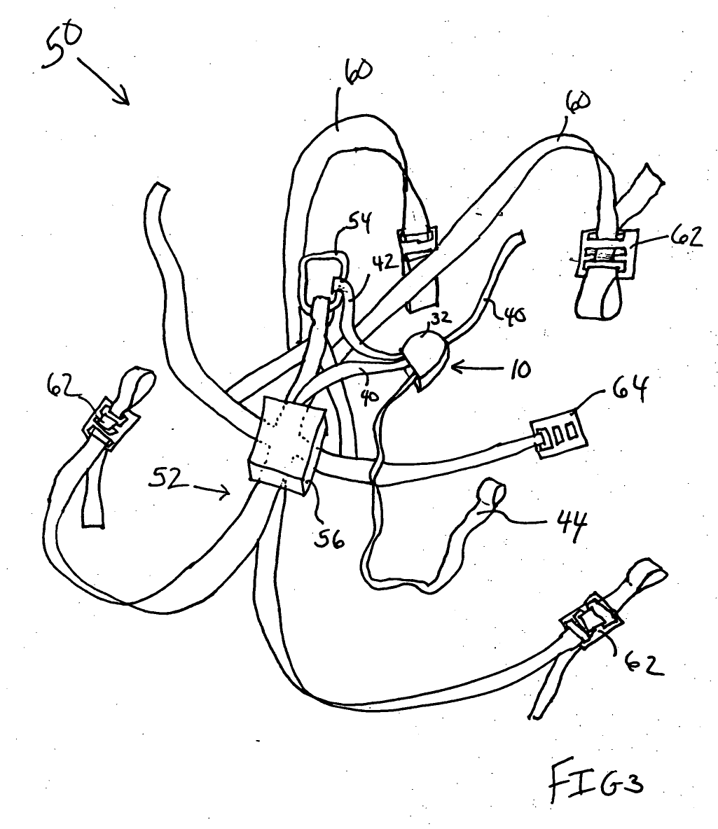

FIG. 3 illustrates a fall protection system 50 to include a harness 52 having a D-ring 54 attached thereto and a pouch 56 mounted thereon. Pouch 56 can be attached to harness 52 with a conventional hook and loop closure attachment. Harness 52 includes straps 60 with adjustment portions 62 and a locking mechanism 64 attached thereto. Adjustment portions 62 are provided with straps 60 to adjust the length of straps 60 when fitting harness 52 to a user. Locking mechanism 64 are adjustable with respect to straps 60 and lock onto straps 60 in order to form the harness 52 that can be secured to the torso of an individual. When harness 52 is strapped on an individual, D-ring 54 is preferably mounted in the back just above pouch 56 as best seen in FIG. 3. Attachment webbing 42 is secured to D-ring 54 of harness 52. While harness 52 is illustrated as multiple straps 60, it is also anticipated that the harness of the present invention could be a vest with straps 60 attached thereto to provide the same function as harness 52.

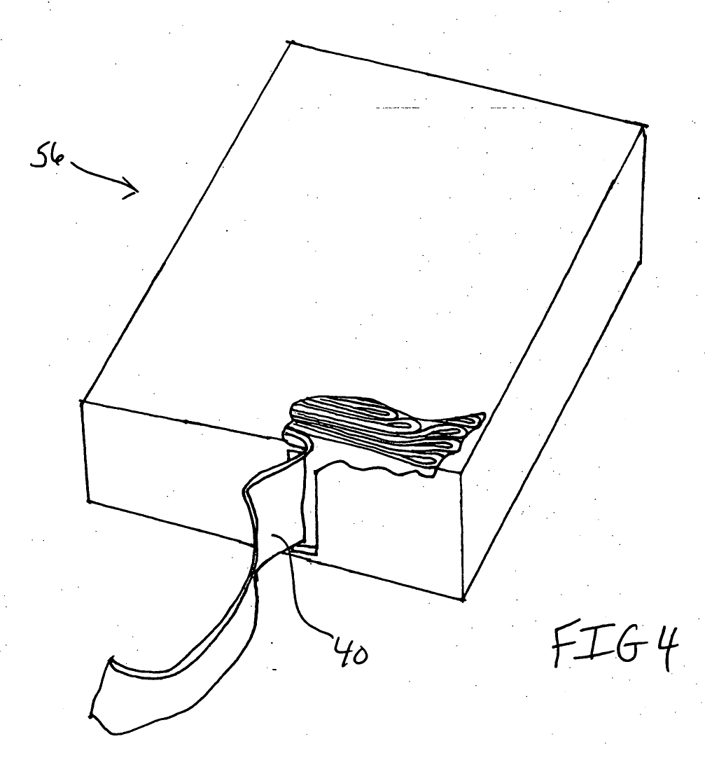

FIG. 4 illustrates pouch 56 including belt 40 folded therein. Pouch 56 is intended to enclose a predetermined length of belt 40 in order to allow an individual that has fallen to rappel safely to the ground as described below. Belt 40 is shown in FIG. 4 to be folded and overlaid within pouch 56 in order to allow belt 40 to self feed from pouch 56 during operation of fall protection system 50.

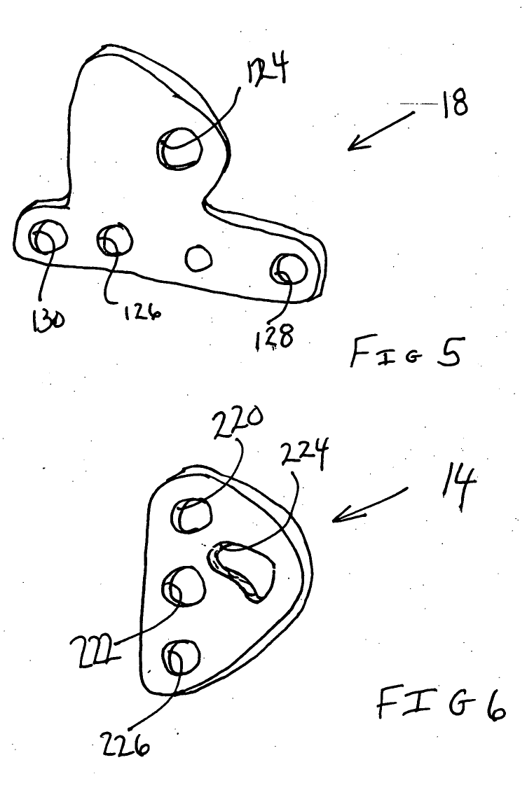

With reference to FIG. 5, release plate 18 is shown in greater detail. Release plate 18 is identical to release plate 16 and is shown to include a locking pin aperture 124, a pivot pin aperture 26, a release pin aperture 128, and an attachment pin aperture 130. FIG. 6 illustrates locking plate 14 to include short pin apertures 220 and 222, a locking pin slot 224, and a pivot pin aperture 226.

When assembled, pivot pin 26 is shown in FIGS. 1 and 2 to be interposed through pivot apertures 126 of pivot plates 16, 18, and pivot apertures 226 of locking plates 12, 14. Pivot pin 26 is interposed through apertures 126, 226 in such a manner as to allow locking plates 12, 14, to rotate relative release plates 16, 18. Short pin 20 is interposed within short pin apertures 220 and short pin 22 is interposed within short pin apertures 222. Locking pin 24 is shown interposed through locking pin apertures 124 and locking pin slots 224. Thus provided, locking pin 24 translates within locking pin slots 224 as lock plates 12, 14 rotate with respect to release plates 16, 18. Belt 40 is positioned within mechanism 10 such that belt 40 threads through a space between short pins 20, 22, around locking pin 24, and back through the space between short pins 20, 22. Attachment pin 30 is interposed within attachment pin apertures 130 and release pin 28 is interposed within release pin apertures 128 and secured therein. Locking pin 24, release pin 28, and attachment pin 30 are securely attached to release plates 16, 18, thereby forming a rigid mechanism 10. This attachment can be accomplished by an interference fit between release plates 16, 18 and locking pin 24, release pin 28, and attachment pin 30 wherein the ends of locking pin 24, release pin 28, and attachment pin 30 are splined, or by any other suitable means. Cover 32 is superposed about the moveable components of mechanism 10. As presently preferred, cover 32 is constructed of injection molded plastic belt 40 is a seat belt webbing, and all other components of mechanism 10 are constructed of 4130 cold rolled steel.

As best seen in FIGS. 2, 5 and 6, as release plates 16, 18 rotate counterclockwise with respect to locking plates 12, 14, the locking pin 24 translates within locking pin slots 224 toward short pins 20, 22. As locking pin 24 translates in this direction, belt 40 is cinched between the surfaces of locking pin 24 and short pins 22 and/or 20. In this manner, counterclockwise rotation of release plates 16, 18 (see FIG. 2), will cause locking pin 24 to tighten belt 40 against short pins 20, 22. This prevents relative movement between belt 40 and locking pin 24. As release plates 16, 18 are counter-rotated or rotated in a clockwise direction, the locking pin 24 rotates away from short pins 20, 22, thereby unlocking belt 40. This allows the belt 40 to travel through rappelling mechanism 10. This clockwise rotation is accomplished by pulling on release strap 44 thereby exerting a force on release plates 16, 18 via release pin 28 in a downward direction with respect to FIG. 2. The amount of force required to release belt 40 is approximately 25% of the individuals body weight.

In operation, the weight of a user will provide a downward reactive force W on attachment pin 28, generally in the direction of arrow D. This force will rotate locking plates 16, 18 counter clockwise thereby locking belt 40 between locking pin 24 and short pins 20, 22. Thus provided, belt 40 is self-locked after a user falls. To descend, the user pulls release strap 44 thereby moving locking pin 24 away from short pins 20, 22. This permits the belt 40 to travel through the rappelling mechanism 10. The amount of force applied by the user to release pin 28 has a component of force P in the direction of arrow D. As belt 40 travels through rappelling mechanism 10, friction between belt 40 and pins 20, 22, and 24 counter acts some of the downward reactive force W, thereby slowing the rate of descent and inhibiting a free fall of the user. The amount of force P applied by the user varies the amount of friction between belt 40 and pins 20, 22, and 24 which, in turn, varies the rate of descent. Thus provided, a user can control the rate of travel of belt 40 through mechanism 10 by selectively regulating the amount of force P applied to release pin 28. It would be appreciated by one skilled in the art that pins 20, 22, and 24 could be provided with a frictional surface, and that belt 40 can be selected to provide a desired coefficient of static and/or dynamic friction during operation of fall protection system 50.

When a fall protection system is desired, an individual is secured within harness 52 such that pouch 56 is located adjacent the individuals rear torso region. Attachment webbing 42 is secured to D-ring 54 thereby providing a positive attachment between rappelling mechanism 10 and harness 52. Pouch 56 is preferably located on a portion of harness 52 that is below rappelling mechanism 10, as seen in FIG. 3. Straps 60 are securely tightened around the person's torso and leg regions using lock mechanisms 64 and adjustment portions 62. In the event of a fall, the weight of an individual is translated through D-ring 54 and attachment webbing 42 to attachment pin 30. This downward force on attachment pin 30 as seen in FIG. 2, causes locking pin 24 to rotate counterclockwise towards short pins 20, 22 thereby locking the rappelling mechanism 10. With rappelling mechanism 10 locked, belt 40 will not translate therethrough, thereby arresting the user's fall. For a controlled descent to the ground or other recovery location, release strap 44 is pulled such that locking pin 24 is moved away from short pins 20, 22 and belt 40 is allowed to slowly translate between locking pin 24 and short pins 20, 22. The rate of descent is controlled by the amount of downward force P exerted on release pin 28 via release strap 44, as discussed above. During descent, the rate of descent can be lowered by exerting less force P on release pin 28. Thus provided, fall protection system 50 allows an individual to control their rate of descent after a fall.

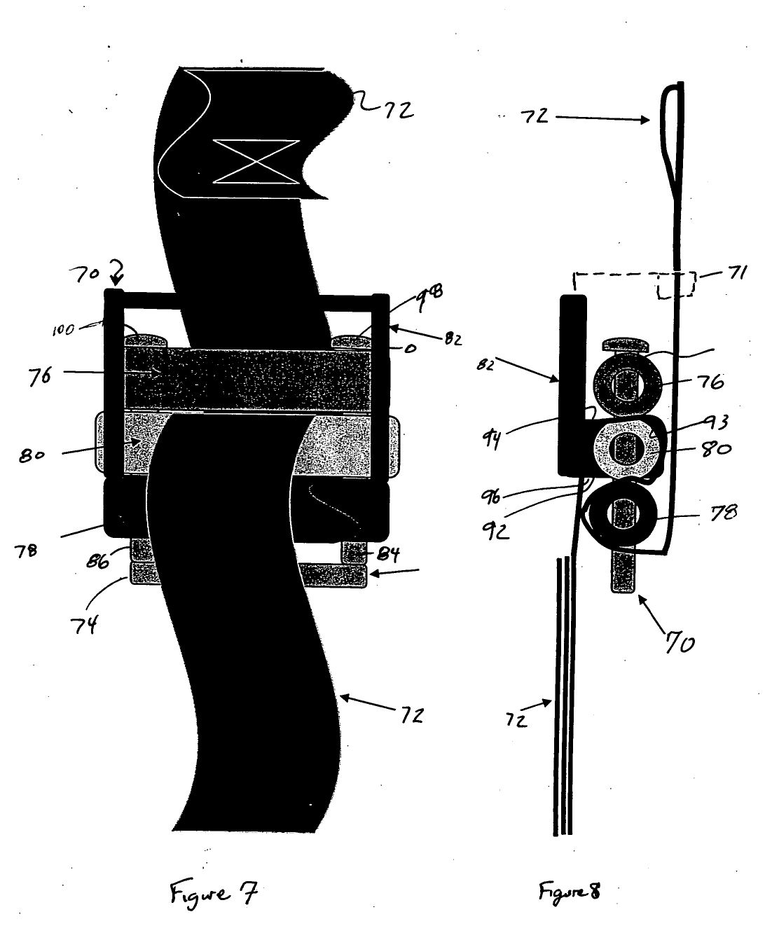

With reference to FIGS. 7 and 8, an alternate rappelling mechanism 70 according to the teachings of the present invention is disclosed. The rappelling mechanism 70 is configured to releasably engage a flat webbing 72 as previously described. The rappelling mechanism 70 has a walking pin support frame 74 which is configured to align three walking locking pins 76, 78, and 80. Coupled to the center locking pin 80 is a release arm 82. The rappelling mechanism 70 is configured to be positioned along a length of webbing 72 and further fixaby coupled the harness 52. In this regard, the rappelling mechanism 70 is disposed between the harness 52 and a fixed point so as to allow a user to manually adjust the distance between the harness 52 and the fixed point along the webbing 72.

The locking pin support frame 74 has a pair of generally parallel lock pin support bars 84 and 86. The lock pin support bars 84 and 86 slidably receive the three walking locking pins 76, 78, and 80. As best seen in FIG. 8, the webbing 72 is serpentinely fed about locking pins 78 and 80. Further, the webbing 72 is fed between the interfacing surfaces of locking pins 76 and 80. It should be noted that the locking pins 76, 78, and 80 are slidable along the locking pin support bars.

The orientation of the locking pins in conjunction with the webbing 72 locks the webbing 72 and prevents relative movement of the webbing with respect to the locking pins 76, 78, and 80. The locking pins 76, 78 and 80 are generally cylindrical and can have an outer surface with a constant radius. Disposed transversely through each pin is a pair of holes which slidably accept the lock pin support bars 84 and 86. It is envisioned the rappelling mechanism 70 can further have a suitable injection molded plastic housing and at least one web guide 71 to maintain the mechanism 70 in a preferred orientation.

The lever release arm 82 has a handle portion 90 and a camming portion 92. The camming portion 92, which is formed of two parallel members 91, has first and second bearing surfaces 94 and 96 which contact locking pins 76 and 78. Members 91 define a through hole 93 that rotatably interfaces with the outer surface 95 of locking pin 80. Rotation of the lever release arm 82 rotates the camming portion 92 with respect to the locking pin 80 and causes the first and second bearing surfaces to apply pressure to surfaces of locking pins 76 and 80. This pressure causes the locking pins 78 and 80 to translate and separate from locking pin 76 along the locking pin support bars. In this regard, while locking pin 76 is pressed against the stop by the lock pin support bar's formed end or stop 98 and 100, locking pins 78 and 80 translate along the locking in support bars. The mechanism is configured so the amount of separation of the locking pins 76, 78 and 80 is proportional to the angle of rotation of the release lever. Upon the loading of the webbing 72 from a user's weight, the webbing 72 pulls the three locking pins 76, 78, and 80 into engagement with the pair of stop members 98 and 100 formed on the locking pin support bars. Specifically, in loading the lock pin support bar toward locking pin 78, the webbing 72 forces lock pin 78 into the center locking pin 80 which in turn forces and traps the webbing 72 into lock pin 76. Lock pin 76 is stopped and held in position by the lock pin support bar's formed end or stop 98 and 100. In this position, the mechanism 70 is in a locked condition and will not payout any webbing 72 until the release lever is pulled.

The speed of the decent is controlled by the magnitude of the forces on release arm 82. To descend slowly, a small rotation is applied to the release arm 82. To descend faster, forces to cause more rotation of the release arm 82 are applied. The removal of forces to the release arm 82 will cause the mechanism 70 to be again put into the locked condition.

The description of the invention is merely exemplary in nature and, thus, variations that do not depart from the gist of the invention are intended to be within the scope of the invention. Such variations are not to be regarded as a departure from the spirit and scope of the invention.

1. A rappelling mechanism comprising:
a flat belt;
a pair of generally parallel locking plates, a locking pin disposed therebetween; and
a pair of generally parallel release plates rotationally coupled to the locking plates, said release plate having a pair of guide pins disposed therebetween, wherein the belt is partially disposed about the guide pins and is further disposed about the locking pin and is further disposed about the locking pin, and wherein rotation of the locking plates with respect to the release plates causes the locking pin to translate with respect to the guide pins.

2. The mechanism according to claim 1 wherein the guide pins are rotationally coupled to the release plates.

3. The mechanism according to claim 1 wherein the locking pin is rotationally coupled to the locking plate.

4. The mechanism according to claim 1 wherein one of the release plates comprises a first lever arm having a first coupling member being a fourth distance from the pivot point.

5. The mechanism according to claim 4 wherein one of the release plates comprises a second lever arm having a second coupling member being a fifth distance from the pivot point.

6. The mechanism according to claim 5 wherein the first and second lever arms are on the first release plate.

7. The mechanism according to claim 6 wherein the fourth distance is greater than the fifth distance.

8. A rappelling mechanism comprising:
a locking member formed of a pair of generally parallel locking plates separated by a locking pin;
a release member formed of a pair of generally parallel release plates separated by a first and second release pin having first and second bearing surfaces, said release mechanism being rotationally coupled to the locking mechanism at a pivot point;
a webbing disposed about the locking pin and contacting the first and second bearing surfaces, wherein the rotation of the locking member with respect to the release member translate the locking pin with respect to one of the release pins.

9. The mechanism according to claim 6 wherein the first release pin is the first radius from the pivot points.

10. The mechanism according to claim 9 wherein the second release pin is a second radius from the pivot point.

11. The mechanism according to claim 10 wherein the locking pin is a third radius from the pivot point.

12. The mechanism according to claim 11 wherein the third radius is greater than the first radius and is less than the second radius.

13. The mechanism according to claim 12 wherein the release pin comprises a first lever arm having a first coupling member being a fourth distance from the pivot point.

14. The mechanism according to claim 13 wherein one of the release plates comprises a second lever arm having a second coupling member being a fifth distance from the pivot point.

15. The mechanism according to claim 14 wherein the first and second lever arms are on the release plate.

16. The mechanism according to claim 15 wherein the fourth distance is greater than the fifth distance.

17. A rappelling mechanism comprising:
a locking member formed of a pair of generally parallel locking bars;
first, second and third walking locking pins slidably coupled to the locking bars;
webbing serpentinely fed about the first and second locking pins and positioned adjacent to a bearing surface of the third pin; wherein the mechanism is configured such that the loading of the webbing toward the second locking pin forces the lock pin into the first locking pin, which in turn forces and traps the webbing into the third lock pin.

18. The rappelling mechanism according to claim 17 wherein the first, second and third locking pins have a generally constant outer radius.

19. The rappelling mechanism according to claim 17 wherein the first, second and third locking pins each define pair of holes which slidably accept the lock support bars.

20. The rappelling mechanism according to claim 17 further comprising:
a lever release arm having a camming portion wherein rotation of the lever release arm rotates the camming portion with respect to the second locking pin and causes first and second bearing surfaces of the camming portion to apply pressure to surfaces of the first and third locking pins.

21. The rappelling mechanism according to claim 20 wherein the camming portion is formed of parallel members, said members defining a through hole that rotatably interfaces with an outer surface of the first locking pin.

22. The rappelling mechanism according to claim 17 wherein locking bars define stop members.
